(19) United States
(12) Patent Application Publication
(10) Pub. No.: US 2016/0369908 A1
(43) Pub. Date: Dec. 22, 2016

(54) Ball Valve Assembly

(71) Applicant: Sensus USA Inc., Raleigh, NC (US)

(72) Inventors: Bernie Kurincak, Carmichael, PA (US); Robert Milon Hill, Apex, NC (US)

(21) Appl. No.: 14/743,565

(22) Filed: Jun. 18, 2015

(51) Int. Cl. F16K 27/06; F16K 5/06

(52) U.S. Cl. CPC F16K 27/067; F16K 5/06

(57) ABSTRACT

According to one aspect of the teachings herein, a ball valve assembly provides a primary flow path and a secondary flow path, where the primary flow path is established by moving the valve into a defined first position and the secondary flow path is established by moving the valve into a defined second position. The secondary flow path substantially restricts fluid flow as compared to the primary flow path and may be regarded as a trickle flow path. In a non-limiting example, the ball valve assembly is used on a water service line and is operated by a utility company. The valve is placed in its first position by authorized personnel, to provide normal, full-flow water service to a residence or other structure, and is placed in its second position, to provide restricted, low-flow water service to the structure.

### TECHNICAL FIELD

The present invention generally relates to valve assemblies for controlling fluid flows, and particularly relates to ball valve assemblies, such as may be used for controlling the flow of water in a water line.

### BACKGROUND

Shut-off valves find widespread use in a variety of industries and across a wide range of fluidic applications. In an example application, public utility companies commonly use curbside valves to control whether or not individual residences are supplied with water. These valves provide on/off functionality in the sense they generally operate in one of two positions: an open position in which the valve allows the full rated flow of water into the residence, and a closed position in which the valve completely shuts off water flow into the residence.

Utility companies shut off water service for a variety of reasons, such as when a structure becomes unoccupied or unused, or when the involved customer fails to pay the water bill. However, the disconnection of water service to a residence may be undesirable because of humanitarian considerations, or may not be permissible in view of applicable laws. In this context and others, the instant inventors have recognized that, paradoxically, it may be desirable for a shut-off valve to provide a position where it does not completely shut off fluid flow, while at the same time greatly restricting the maximum flow rate through the valve.

### SUMMARY

According to one aspect of the teachings herein, a ball valve assembly provides a primary flow path and a secondary flow path, where the primary flow path is established by moving the valve into a defined first position and the secondary flow path is established by moving the valve into a defined second position. The secondary flow path substantially restricts fluid flow as compared to the primary flow path and may be regarded as a trickle flow path. In a non-limiting example, the ball valve assembly is used on a water service line and is operated by a utility company. The ball valve assembly is placed in its first position by authorized personnel, to provide normal, full-flow water service to a residence or other structure, and is placed in its trickle position, to provide restricted, low-flow water service to the structure. Further, in one or more embodiments, the valve has a defined third position in which it completely shuts off flow through the assembly.

In an example embodiment, a ball valve assembly has a primary flow path running from a fluid inlet of the ball valve assembly to a fluid outlet of the ball valve assembly and a ball disposed within the primary flow path that is operable when rotated into a defined first position to duct fluid from the fluid inlet to the fluid outlet, and is operable when rotated into a defined second position to block the primary flow path on an upstream side of the ball, while simultaneously establishing a secondary flow path that is more restrictive than the primary flow path. The ball in its second position establishes the secondary flow path by placing the fluid outlet in fluid communication with a valve chamber surrounding the ball, where the secondary flow path further including one or more secondary fluid passageways within the ball valve assembly that place the fluid inlet in fluid communication with the valve chamber and are open irrespective of the position of the ball.

With the arrangement immediately above, it will be understood that the one or more secondary fluid passageways supply fluid to the valve chamber irrespective of the rotational position of the ball. However, the ball seals the valve chamber from the fluid outlet unless the ball occupies its defined second position. In that second position, the ball 34 ducts fluid from the valve chamber to the fluid outlet. In the same or in another example embodiment, the ball valve assembly further defines a third position for the ball, where no flow path exists through the ball valve assembly. Thus, in the first position, fluid flows directly from the fluid inlet of the ball valve assembly to the fluid outlet of the ball valve assembly—it will be understood that this flow pass through the ball. However, in the second position, fluid flows from the fluid inlet and into the valve chamber via the one or more secondary fluid passageways—which can be understood as intentional leakage paths—and from there through the ball and on into the fluid outlet of the ball valve assembly. Also in this context, rotation of the ball into a defined third position operates as a shutoff position by blocking any fluid from reaching the fluid outlet.

In a more detailed example applicable to the same or another embodiment, the ball valve assembly comprises a housing having an inlet coupling section, an outlet coupling section, and a valve section therebetween. The valve section defines a valve chamber, the inlet coupling section defines an inlet chamber, and the outlet coupling section defines an outlet chamber. An inlet port opens from the inlet chamber into the valve chamber through an inlet ball seat and a corresponding outlet port opens from the valve chamber into the outlet chamber through an outlet ball seat, while a ball is rotatably carried within the valve chamber and sealingly engaged between the inlet and outlet ball seats.

When the ball is rotated into a defined first position, a first bore through the ball places the inlet chamber in fluid communication with the outlet chamber, and, when the ball is rotated into a defined second position, the first bore is open to the valve chamber, the ball blocks the inlet ball seat, and a second bore in the ball places the outlet chamber in fluid communication with the valve chamber via the first bore. Correspondingly, a secondary fluid passageway bypasses the ball and places the inlet chamber in fluid communication with the valve chamber, thereby forming, in conjunction with valve chamber and the first and second bores, a restricted or secondary flow path from the inlet chamber to the outlet chamber that is operative when the ball occupies the second position.

The ball valve assembly may further define a third position for the ball, wherein all flow through the ball valve assembly is cutoff. Consequently, the ball valve assembly in such embodiments may be understood as providing three defined positions for the ball: a first or open position that provides for a “normal” or “regular” flow through the ball valve assembly, a second or trickle position that provides for a “restricted” or “trickle” flow through the ball valve assembly, and a third or closed position that prevents any flow through the ball valve assembly. By way of non-limiting example, the trickle flow is a restricted flow in the sense that, under the same head conditions, the trickle flow rate is no more than a tenth the normal flow, and may be considerably less, according to design preferences.

In the same or in another example embodiment, a ball valve assembly comprises a housing defining an interior valve chamber housing a ball that is rotatably seated between an inlet ball seat opening towards an upstream fluid inlet of the ball valve assembly and an outlet ball seat opening towards a downstream fluid outlet of the ball valve assembly. In a first position the ball ducts fluid from the fluid inlet to the fluid outlet, and in a second position the ball blocks the inlet ball seat and ducts fluid from the valve chamber to the fluid outlet. Correspondingly, the ball valve assembly includes a bypass or secondary fluid passageway that bypasses the ball and supplies fluid from the fluid inlet to the valve chamber, for ducting by the ball from the valve chamber to the fluid outlet when the ball is in the second position.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 is a cross-sectional side view of one embodiment of a ball valve assembly.

FIG. 2 is a top view of the ball valve assembly.

FIG. 3 is an exploded view of the ball valve assembly.

FIG. 4 is an end view of an inlet end of the ball valve assembly.

FIG. 5 is an end view of an outlet end of the ball valve assembly.

FIG. 6 is a perspective front-side view of the ball valve assembly.

FIG. 7 is a perspective back-side view of the ball valve assembly.

FIG. 8 is a perspective view of one embodiment of a ball, for use in the ball valve assembly.

FIG. 9 is a cross-sectional top view of the ball valve assembly, where the ball of FIG. 8 is rotated into a first position associated with a primary flow path through the ball valve assembly.

FIG. 10 is a cross-sectional top view of the ball valve assembly, where the ball of FIG. 8 is rotated into a second position associated with a secondary flow path through the ball valve assembly.

### DETAILED DESCRIPTION

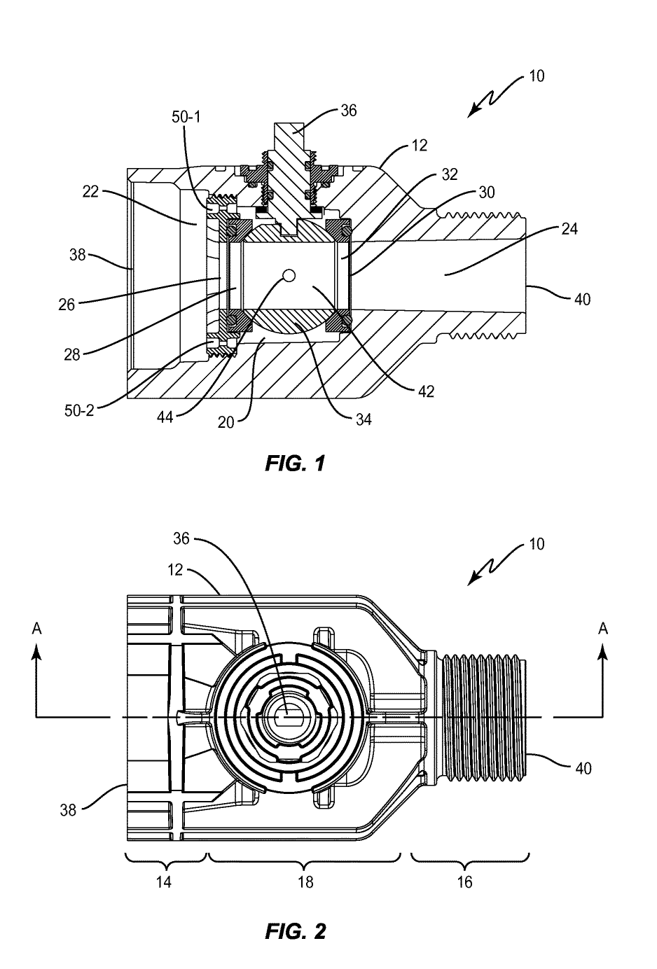

FIG. 1 is a cross-sectional side view of a ball valve assembly 10 according to an example embodiment and FIG. 2 is a top view of the same assembly. The cut line A-A depicted in FIG. 2 corresponds to the cross-sectional view of FIG. 1.

With reference to both figures, the ball valve assembly 10 comprises a housing 12 having an inlet coupling section 14, an outlet coupling section 16, and a valve section 18 therebetween. The inlet and outlet coupling sections 14 and 16 are configured, for example, for making up connections with upstream and downstream piping.

The valve section 18 defines a valve chamber 20, the inlet coupling section 14 defines an inlet chamber 22 and the outlet coupling section 16 defines an outlet chamber 24. An inlet port 26 opens from the inlet chamber 22 into the valve chamber 20 through an inlet ball seat 28 and a corresponding outlet port 30 opens from the valve chamber 20 into the outlet chamber 24 through an outlet ball seat 32.

A ball 34 is rotatably carried within the valve chamber 20 and is sealingly engaged between the inlet and outlet ball seats 28 and 32. The ball 34 is connected to a valve stem 36 that projects through the housing 12 and provides a mechanism for maintaining or otherwise fixing the ball 34 in position within the valve chamber 20 in sealing engagement with the inlet and outlet ball seats 28 and 32. The valve stem 36 is rotatable and thus provides an external mechanism by which the ball 34 is rotated, either manually or by machine control.

Water or another fluid passing through the ball valve assembly 10 enters via a fluid inlet 38 of the ball valve assembly 10 and exits through a fluid outlet 40 of the ball valve assembly. When the ball 34 is rotated into a first position, a first bore 42 through the ball 34 places the inlet chamber 22 in fluid communication with the outlet chamber 24. When the ball 34 is rotated into a second position, the first bore 42 is open to the valve chamber 20, the ball 34 blocks the inlet ball seat 28, and a second bore 44 in the ball 34 places the outlet chamber 24 in fluid communication with the valve chamber 20 via the first bore 42.

In saying that the ball 34 “blocks” the inlet ball seat 28, the reader will understand that an un-bored or closed surface portion of the ball 34 will be turned into an upstream-facing position when the ball 34 is rotated into the second position, and that closed ball face will be sealed against the inlet ball seat 28 and will thus block the interior bore of the inlet ball seat 28. Later diagrams provide a more detailed depiction of this arrangement.

However, despite the ball 34 blocking the normal fluid flow path through the inlet ball seat 28 when rotated into its second position, a secondary fluid passageway 50 bypasses the ball 34 and places the inlet chamber 22 in fluid communication with the valve chamber 20. This arrangement, in conjunction with the valve chamber 20 and the first and second bores 42 and 44 of the ball 34 as they are oriented when the ball 34 is in the second position, form a restricted or secondary flow path from the inlet chamber 22 to the outlet chamber 24 that is operative when the ball 34 occupies the second position.

A better understanding of the secondary fluid passageway 50 is gained with reference to FIG. 1, where two such secondary fluid passageways are shown as 50-1 and 50-2. In the illustrated example, the two secondary fluid passageways 50-1 and 50-2 are formed within the body of the housing 12, e.g., either by machining, molding or extruding the housing 12 to include such passageways. Critically, these secondary fluid passageways 50-1 and 50-2 are open independent of the rotation of the ball 34; that is, they are not blocked even when the ball 34 is rotated into its second position, which places the first bore 42 of the ball 34 crosswise with respect to the normal flow path and blocks the inlet ball seat 28.

The reference number 50 shall be used without suffixing, for generic reference to a single secondary fluid passageway, and for generically referencing any number of secondary fluid passageways. Further, it shall be understood that this disclosure contemplates embodiments of the ball valve assembly 10 that include a single secondary fluid passageway 50, or two or more secondary fluid passageways 50. A secondary fluid passageway 50 may be formed or machined in the housing 12 or in the inlet ball seat 28. In the latter case, it will be understood that the inlet ball seat 28 is purposefully constructed to be “leaky” according to some desired restricted flow rate and that, although the ball 34 is still operable to seal the main pathway through the inlet ball seat 28, one or more secondary fluid passageways 50 are formed within the inlet ball seat 28, to allow the fluid to flow around or past the ball 34 when the ball is in its trickle position, and into the valve chamber 20, albeit at a much restricted flow rate.

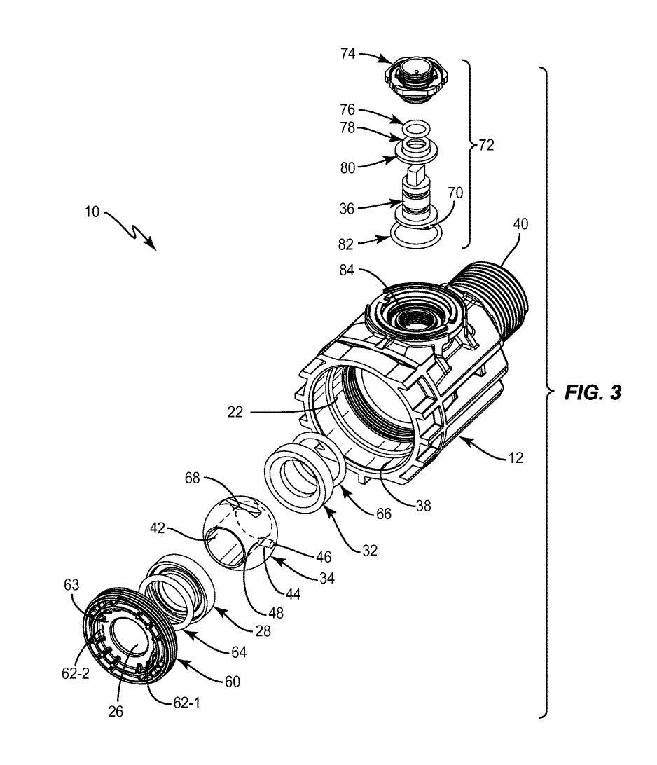

In one or more embodiments, there is a plurality of secondary fluid passageways 50, and the aggregate cross-sectional area of the plurality of secondary fluid passageways 50 is equal to or greater than the cross-sectional area of the second bore 44 in the ball. For example, in the exploded view of FIG. 3, one sees that an inlet ring section 60 may be used to define the inlet chamber 22—i.e., to separate the inlet chamber 22 from the valve chamber 20—and to couple with the inlet ball seat 28 on the upstream side.

The inlet ring section 60 in the depicted embodiment includes a number of upstream openings 62, e.g., 62-1 and 62-2, in an inlet face 63 of the inlet ring section 60. The inlet face 63 faces upstream and the plurality of upstream openings 62 are distributed in the inlet face 63 around the inlet port 26, which is defined within the inlet face 63. While the secondary fluid passageways 50 are not visible in FIG. 3, the reader will appreciate that each upstream opening 62 serves as an inlet into a corresponding secondary fluid passageway 50, for ducting fluid from the inlet chamber 22 into the valve chamber 20.

The upstream openings 62 in the inlet ring section 60 are not needed in embodiments where the secondary fluid passageway(s) 50 are formed within the inlet ball seat 28, such that the inlet ball seat 28 provides controlled leakage around the ball 34. In at least one such embodiment, there is a potentially large plurality of secondary fluid passageways 50, as the inlet ball seat 28 is formed from a porous material, such as from POREX brand porous PTFE or another porous material suitable for use as a ball valve seat.

As seen in FIG. 3, the inlet ball seat 28 has a generally ring or cylindrical shape and may couple to the inlet ring section 60 via a gasket 64. A similar gasket or sealing ring 66 may be used on the outlet ball seat 32.

FIG. 3 also illustrates example details for the ball 34, including a valve stem slot 68, which is engaged by a the valve stem key 70 that projects from a bottom end of the valve stem 36. The overall valve stem assembly 72 includes a top portion 74 that is engaged by an electro-mechanical drive system—not shown—for rotation of the ball 34, along with various washers 76, 78, 80 and 82. The valve stem assembly 72 projects through an opening 84 in the housing 12 of the ball valve assembly 10, for engaging the ball 34 and retaining the ball 34 in position with the valve chamber 20—i.e., the valve stem assembly 72 passes through the housing 12 and retains the ball 34 in a floating, rotatable engagement with the inlet and outlet ball seats 28 and 32.

Also as seen in FIG. 3, the inlet ball seat 28 has a bore or inner barrel that opens at one end, the upstream end, towards the inlet chamber 22 of the ball valve assembly 10. The inlet ball seat bore opens at the downstream side towards the valve chamber 20. When the ball 34 is rotated into its first or open position, the first bore 42 aligns with the bore of the inlet ball seat 28 and thus provides a continuous fluid pathway into the outlet chamber 24. When the ball 34 is rotated into its defined second position, the first bore 42 is rotated out of alignment with the inlet and outlet ball seat bores, and a closed, un-bored surface of the ball 34 blocks the downstream bore opening of the inlet ball seat 28. Correspondingly, the second bore 44 is rotated into alignment with the outlet ball seat 32.

Thus, when the ball 34 is rotated into its second position, the ends of the first bore 42 of the ball 34 opens into the valve chamber 20, and the second bore 44 opens into the outlet chamber 24 through the outlet ball seat 32. Here, it will be appreciated that the first bore 42 of the ball 34 runs diametrically through the ball 34 and the second bore 44 of the ball 34 is perpendicular to the first bore 42. The second bore 44 opens at one end 46 into the exterior of the ball 34 and at the other end 48 into the interior wall of the first bore 42. When the ball 34 is rotated substantially ninety degrees around an axis of rotation, it is moved from its first, open position to its second, trickle or leakage position. In the second position, the end 46 of the second bore 44 aligns with the bore of the outlet ball set 32 and the ends of the first bore 42 are open to the valve chamber 20.

Thus, the first bore 42 through the ball 34 can be understood as forming part of a primary flow path through the ball valve assembly 10 when it is rotated into alignment with the inlet and outlet ports 26 and 30 of the ball valve assembly 10. Conversely, when the first bore 42 is rotated crosswise to the primary flow path, its respective ends open into the valve chamber 20, and allow fluid to flow from the valve chamber 20 into the first bore 42 and further through the second bore 44, which aligns with the outlet port 30 when the ball 34 occupies the second position.

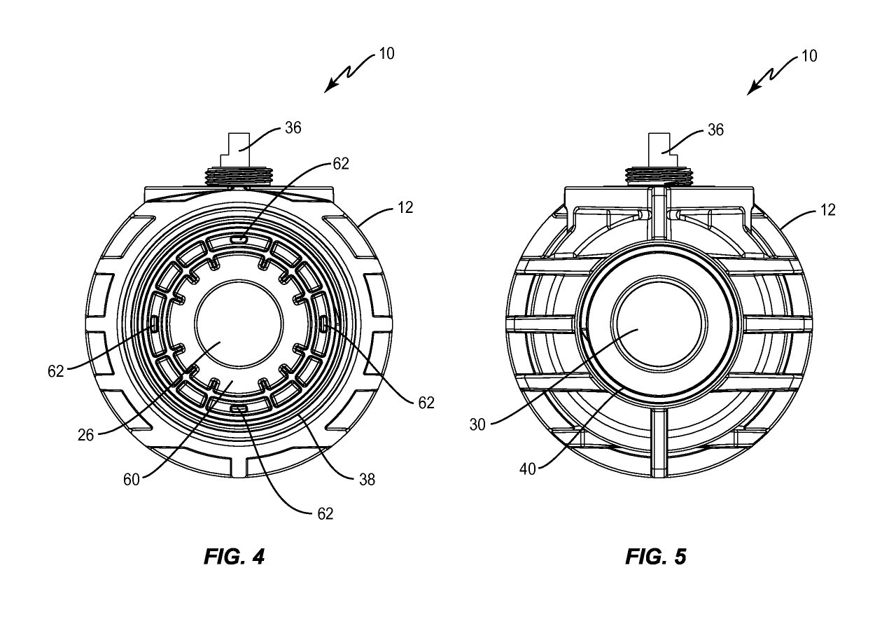

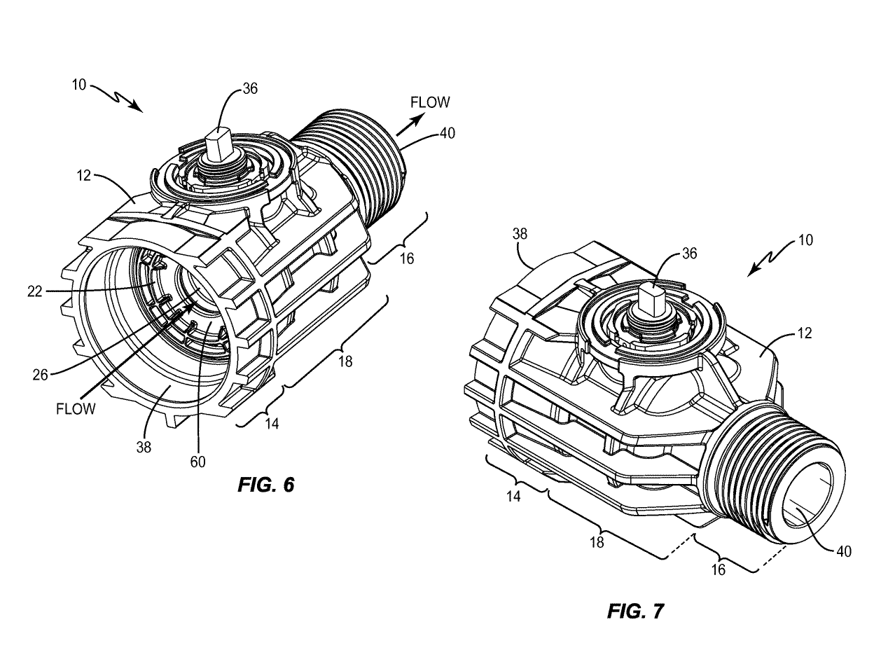

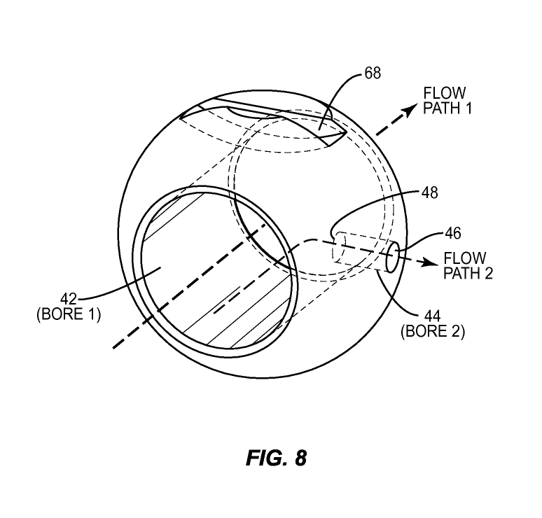

This functionality may be better appreciated with respect to the various views provided in FIGS. 4-8. In particular, FIGS. 4 and 5 illustrate upstream and downstream ends of the ball valve assembly 10, FIGS. 6 and 7 illustrate perspective front-quarter and rear-quarter views of the ball valve assembly 10, and FIG. 8 illustrates the ball 34 in closer detail.

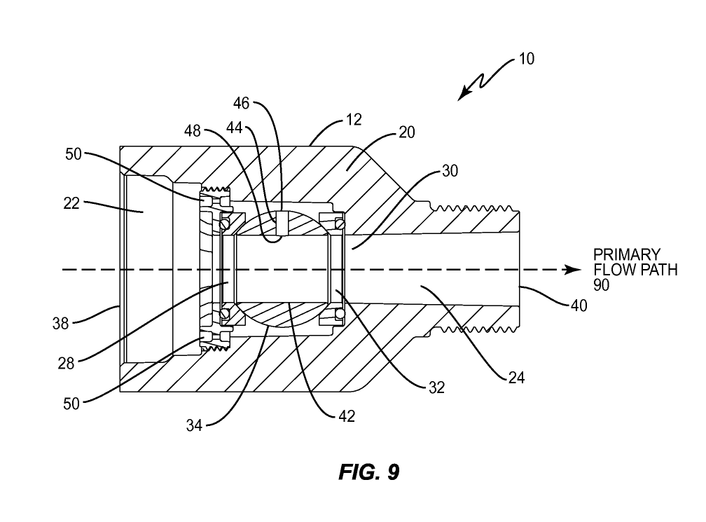

One sees that the first bore 42 in an end-to-end sense forms part of the primary flow path, denoted as flow path 1. The first bore 42 also forms a part of the secondary flow path, denoted as flow path 2. FIG. 9 provides a cross-sectional plan view of the ball valve assembly 10 and relates these ball details to the overall assembly 10. In particular, FIG. 9 depicts the ball 34 rotated into the first position such that a primary flow path 90 is established from the fluid inlet 38 of the overall ball valve assembly 10 to the fluid outlet 40 of the overall ball valve assembly 10. The primary flow path 90 is completed by rotating the first bore 42 of the ball 34 into alignment with the assembly inlet 38 and outlet 40.

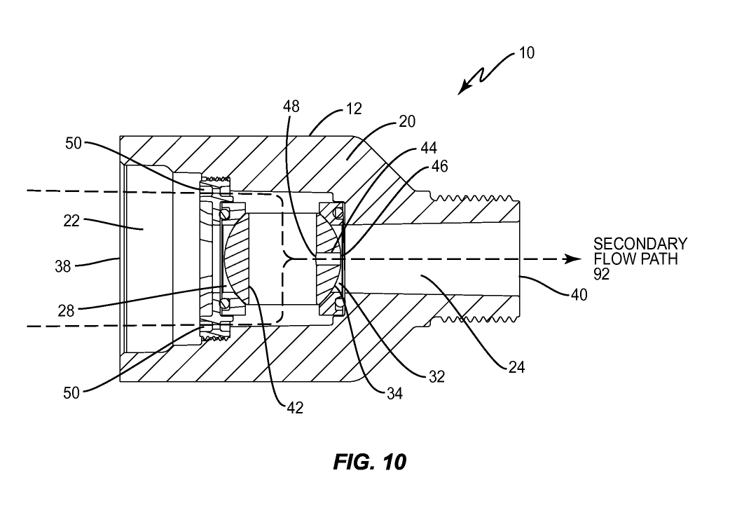

FIG. 10 provides the same view but where the ball 34 is rotated into the second position, with the first bore 42 now positioned perpendicular to the direction of flow through the inlet 38 and outlet 40, and with the second bore 44 aligned with the outlet 40. This position of the ball 34 establishes a secondary flow path 92 from the inlet 38 to the outlet 40, where the fluid flows through the one or more secondary fluid passageways 50, into the valve chamber 20, through the ends of the first bore 42, which open into the valve chamber 20, and through the second bore 44. The second bore 44 opens through the outlet ball seat 32 into the outlet chamber 24.

Of course, the details of FIGS. 9 and 10 should be understood as exemplary and not limiting. Broadly, in one or more embodiments contemplated herein, a ball valve assembly 10 has a primary flow path 90 running from a fluid inlet 38 of the ball valve assembly 10 to a fluid outlet 40 of the ball valve assembly 10. A ball 34 disposed within the primary flow path 90 is operable when rotated into a first position to duct fluid from the fluid inlet 38 to the fluid outlet 40, and is operable when rotated into a second position to block the primary flow path 90 on an upstream side of the ball 34 while simultaneously placing the fluid outlet 40 in fluid communication with a valve chamber 20 surrounding the ball 34.

The ball valve assembly 10 further provides or defines a secondary flow 92 path that is more restrictive than the primary flow path 90 and formed by the ball 34 in its second position and one or more secondary fluid passageways 50 that place the fluid inlet 38 in fluid communication with the valve chamber 20. These secondary fluid passageways 50 are open irrespective of the position of the ball 34, and thus provide a leakage path around the ball 34 in its trickle position. Of course, the rated flow rate of the secondary flow path 92 may be much less than that of the primary flow path 90. That is, the ball valve assembly 10 can be configured via proper sizing of the second bore 44 and the secondary fluid passageways 50 to provide a secondary-path maximum flow rate that is one-tenth or less, e.g., one-fiftieth, of the maximum flow rate of the primary flow path 90.

With the above details in mind, according to the teachings herein a ball valve assembly 10 comprises a housing 12 defining an interior valve chamber 20 housing a ball 34 rotatably seated between an inlet ball seat 28 opening towards an upstream fluid inlet 38 of the ball valve assembly 10 and an outlet ball seat 32 opening towards a downstream fluid outlet 40 of the ball valve assembly 10. In a first position, the ball 34 ducts fluid from the fluid inlet 38 to the fluid outlet 40. In a second position, the ball 34 blocks the inlet ball seat 28 and ducts fluid from the valve chamber 20 to the fluid outlet 40. Correspondingly, the ball valve assembly 10 includes a secondary fluid passageway 50 that bypasses the ball 34 and supplies fluid from the fluid inlet 38 to the valve chamber 20, for ducting by the ball 34 from the valve chamber 20 to the fluid outlet 40 when the ball 34 is in the second position.

Also, as noted, the ball valve assembly 10 may define or otherwise provide for rotation of the ball 34 into a third position, where the ball valve assembly 10 is closed and prevents all flow through it. For example, with reference to FIGS. 3 and 8, the ball 34 in its third position will have the second bore 44 facing the inlet ball seat 28, which in turn causes the diametrically opposite, closed surface of the ball 34 to seal off the outlet ball seat 32. That is, when the ball 34 occupies the third position, the outlet ball seat 32 is not open to the inlet ball seat 28 via the first bore 42 of the ball 34, nor is the outlet ball seat 32 open to the valve chamber 20 via the combination of first and second bores 42 and 44 of the ball 34.

Thus, the first position of the ball 34 provides for a maximum flow rate through the ball valve assembly 10, the second position of the ball 34 provides for a restricted flow rate through the ball valve assembly 10, e.g., essentially a trickle flow, and the third position of the ball 34 provides a traditional closed or shut-off position. In one or more embodiments, the valve stem assembly 72 includes detents or other mechanical features that define the first, second and third ball positions, or that otherwise provide for positive engagement of the defined ball positions.

Moreover, the exterior of the housing 12 in one or more embodiments is inscribed or otherwise labeled with indicia indicating the defined ball positions. In this regard, while it may be possible in some embodiments to position or leave the ball 34 in a rotational position between defined positions, the ball valve assembly 10 is not designed for operation in any such undefined position. Correspondingly, it will be understood that the ball valve assembly 10 provides the designed—for regular flow and the designed—for trickle flow when the ball 34 occupies the first or second positions, respectively.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. A ball valve assembly comprising:
a housing having an inlet coupling section, an outlet coupling section, and a valve section therebetween, wherein the valve section defines a valve chamber, the inlet coupling section defines an inlet chamber, and the outlet coupling section defines an outlet chamber;
an inlet port opening from the inlet chamber into the valve chamber through an inlet ball seat and a corresponding outlet port opening from the valve chamber into the outlet chamber through an outlet ball seat;
a ball rotatably carried within the valve chamber and sealingly engaged between the inlet and outlet ball seats, wherein, when the ball is rotated into a defined first position, a first bore through the ball places the inlet chamber in fluid communication with the outlet chamber, and, when the ball is rotated into a defined second position, the first bore is open to the valve chamber, the ball blocks the inlet ball seat, and a second bore in the ball places the outlet chamber in fluid communication with the valve chamber via the first bore; and
a secondary fluid passageway that bypasses the ball and places the inlet chamber in fluid communication with the valve chamber, thereby forming, in conjunction with valve chamber and the first and second bores, a restricted flow path from the inlet chamber to the outlet chamber that is operative when the ball occupies the second position.

2. The ball valve assembly of claim 1, wherein the secondary fluid passageway is formed or machined in the housing, or in the inlet ball seat.

3. The ball valve assembly of claim 2, wherein the secondary fluid passageway comprises a plurality of secondary fluid passageways.

4. The ball valve assembly of claim 3, wherein an aggregate cross-sectional area of the plurality of secondary fluid passageways is equal to or greater than the cross-sectional area of the second bore in the ball.

5. The ball valve assembly of claim 3, wherein the inlet chamber includes an inlet face around the inlet port, and wherein upstream openings of the plurality of secondary fluid passageways are distributed in the inlet face around the inlet port.

6. The ball valve assembly of claim 1, wherein at least a portion of the inlet ball seat that is exposed to fluid upstream from the ball is porous and functions as the secondary fluid passageway.

7. The ball valve assembly of claim 1, wherein the inlet ball seat comprises a bore open at one end to the inlet chamber and selectively open to or blocked at the other end by the ball, said bore including at least a section that is porous and thereby provides the secondary fluid passageway.

8. The ball valve assembly of claim 1, wherein the first bore of the ball runs diametrically through the ball and the second bore of the ball is perpendicular to the first bore, so that the ball rotates substantially ninety degrees around an axis of rotation when moved from the first position to the second position.

9. The ball valve assembly of claim 1, further comprising a stem assembly passing through the housing and retaining the ball in a floating, rotatable engagement with the inlet and outlet ball seats.

10. The ball valve assembly of claim 1, wherein, in addition to the first and second positions, the ball valve assembly is configured to provide for rotation of the ball into a defined third position, in which the ball seals the outlet ball seat and thereby prevents any flow through the ball valve assembly.

11. A ball valve assembly having a primary flow path running from a fluid inlet of the ball valve assembly to a fluid outlet of the ball valve assembly and a ball disposed within the primary flow path that is operable when rotated into a defined first position to duct fluid from the fluid inlet to the fluid outlet, and is operable when rotated into a defined second position to block the primary flow path on an upstream side of the ball while simultaneously establishing a secondary flow path that is more restrictive than the primary flow path, by placing the fluid outlet in fluid communication with a valve chamber surrounding the ball, said secondary flow path further including one or more secondary fluid passageways within the ball valve assembly that place the fluid inlet in fluid communication with the valve chamber and are open irrespective of the position of the ball.

12. A ball valve assembly comprising:
a housing defining an interior valve chamber housing a ball rotatably seated between an inlet ball seat opening towards an upstream fluid inlet of the ball valve assembly and an outlet ball seat opening towards a downstream fluid outlet of the ball valve assembly, wherein in a defined first position the ball ducts fluid from the fluid inlet to the fluid outlet, and in a defined second position blocks the inlet ball seat and ducts fluid from the valve chamber to the fluid outlet;
wherein said ball valve assembly includes a secondary fluid passageway that bypasses the ball and supplies fluid from the fluid inlet to the valve chamber, for ducting by the ball from the valve chamber to the fluid outlet when the ball is in the second position.
